(19) United States
(12) Patent Application Publication
(10) Pub. No.: US 2023/0368106 A1
(43) Pub. Date: Nov. 16, 2023

(54) EFFICIENT NETWORK GRAPH DECOMPOSITION USING UNCONSTRAINED RESOURCE NODES

(71) Applicant: Oracle International Corporation, Redwood Shores, CA (US)

(72) Inventors: Corneliu Muntean, Thornhill, CA (US); Mukundan Srinivasan, Union City, CA (US); Yongxing Guo, Foster City, CA (US)

(73) Assignee: Oracle International Corporation, Redwood Shores, CA (US)

(21) Appl. No.: 17/744,382

(22) Filed: May 13, 2022

(51) Int. Cl. G06Q 10/06

(52) U.S. Cl. CPC G06Q 10/0633

(57) ABSTRACT

A network may be organized to provide components. Components may be generated by combining other components (sub-components) together, and components may be provided by resources in the network. This network may be represented by a graph of nodes representing components and resources. In order to efficiently analyze this graph to generate a network plan, the graph may be subdivided into independent sub-graphs. Individual resources may be shared by individual sub-graphs and considered independent when those resources are underutilized or otherwise unconstrained. Models may be used to predict which resources are unconstrained and allow those resources to be shared by otherwise independent sub-graphs, thereby increasing the decomposition of the graph and improving the efficiency of the network plan analysis.

### BACKGROUND

Enterprises across various industries involved in manufacturing, distribution, and retail need accurate and up-to-date supply chains plans for optimal performance and to react to changing business needs. Using inputs such as customer orders/forecasts, the sourcing network, bills of materials and routings, substitutes and alternates, material and capacity constraints, and multiple business objectives, these supply chain plans provide detailed, near optimal, and constraint-feasible recommendations on what, how much, and when to manufacture, buy, and/or distribute, often for a year out or more.

These plans deal with several million decision variables and constraints with complex dependences among them with the need to optimize on multiple business objectives. These plans typically need to be run on a daily basis—and sometimes a few times a day—to account for changing needs, but generating a feasible and optimal supply chain plan takes several hours or even a day, and the available time window is often not sufficient to accommodate this timeframe. Therefore, any method that can help reduce the run time while keeping the solution quality intact is highly sought after.

### SUMMARY

This disclosure describes techniques for efficiently decomposing a network graph into independent sub-graphs that share unconstrained resources. A network may be organized to provide components. Components may be generated by combining other components (sub-components) together, and components may be provided by resources in the network. This network may be represented by a graph of nodes representing components and resources. In order to efficiently analyze this graph to generate a network plan, the graph may be subdivided into independent sub-graphs. Individual resources may be shared by individual sub-graphs and considered independent when those resources are underutilized or otherwise unconstrained. Models may be used to predict which resources are unconstrained and allow those resources to be shared by otherwise independent sub-graphs, thereby increasing the decomposition of the graph and improving the efficiency of the network plan analysis.

Some embodiments may use machine-learning models to predict which resources may be considered unrestrained, even though multiple dependencies exist between subgraphs. Models may be trained using previous network plans to generate labels for the training inputs. The training inputs may include any of the model inputs, such as the network graph, and/or any other inputs provided to the network planning process. To generate the training labels, a previous network plan may be analyzed to identify probable bottlenecks on resources based on the forecasted quantities of various components. These data may be used to generate tables of projected demand for the components using certain resources. Logistic and/or linear regression models, as well as neural networks may be used and evaluated by a validation procedure to identify the most accurate models to use in the prediction process. After predicting the resources on which the constraints may be relaxed, indications of these resources may be passed to a graph decomposition process to further subdivide the graph for more efficient processing.

### BRIEF DESCRIPTION OF THE DRAWINGS

A further understanding of the nature and advantages of various embodiments may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 illustrates a user interface that displays a partial view of a network plan, according to some embodiments.

FIG. 2 illustrates a diagram of a network represented by a graph, according to some embodiments.

FIG. 3A illustrates a graph that cannot initially be divided into independent sub-graphs based on dependencies alone, according to some embodiments.

FIG. 3B illustrates how the graph can be divided into independent sub-graphs by relaxing constraints on dependencies, according to some embodiments.

FIG. 4 illustrates a flowchart of a process for efficiently subdividing a graph into sub-graphs when generating a network plan, according to some embodiments.

FIG. 5 illustrates a flowchart of a method for using and training a machine-learning model to identify unconstrained nodes, according to some embodiments.

FIG. 6 illustrates an example of resource usage per component that may be used to generate training data, according to some embodiments.

FIG. 7 illustrates an example of component requirements per individual time window, according to some embodiments.

FIG. 8 illustrates an example of training data that may be derived from the resource and component information, according to some embodiments.

FIG. 9 illustrates data used in a logistic regression model, according to some embodiments.

FIG. 10 illustrates a flowchart of a method of decomposing graphs of networks and independent sub-graphs based on node constraints, according to some embodiments.

FIG. 11 illustrates a simplified block diagram of a distributed system for implementing some of the embodiments.

FIG. 12 illustrates a simplified block diagram of components of a system environment by which services provided by the components of an embodiment system may be offered as cloud services.

FIG. 13 illustrates an exemplary computer system, in which various embodiments may be implemented.

### DETAILED DESCRIPTION

Described herein are embodiments for efficiently decomposing a network graph into independent sub-graphs that share unconstrained resources. A network may be organized to provide components, which may be generated by combining other components (sub-components) together, and sub-components may be provided by resources in the network. This network may be represented by a graph of nodes representing components and resources. In order to efficiently analyze this graph to generate a network plan, the graph may be subdivided into independent sub-graphs. Individual resources may be shared by individual sub-graphs and considered independent when those resources are underutilized. Models may be used to predict which resources are underutilized and allow those resources to be shared by otherwise independent sub-graphs as though they were unconstrained, thereby increasing the decomposition of the graph and improving the efficiency of the network plan analysis.

A network of interconnected components, subcomponents, assembly items, sub-assemblies, raw materials, substitute materials, suppliers, transportation resources, and so forth, may be represented by data structures in a computer system and analyzed to develop a comprehensive network plan of components provided by the network. One example of a network may include a supply chain network, where the entities represent different suppliers, machines, locations, destinations, and other entities that may be involved in the supply chain network. Another example of a network may include a network of computer resources that are used or consumed by computing workstations, servers, or other processes. These example networks are provided only by way of example and are not meant to be limiting. Any other network benefit from the techniques described herein.

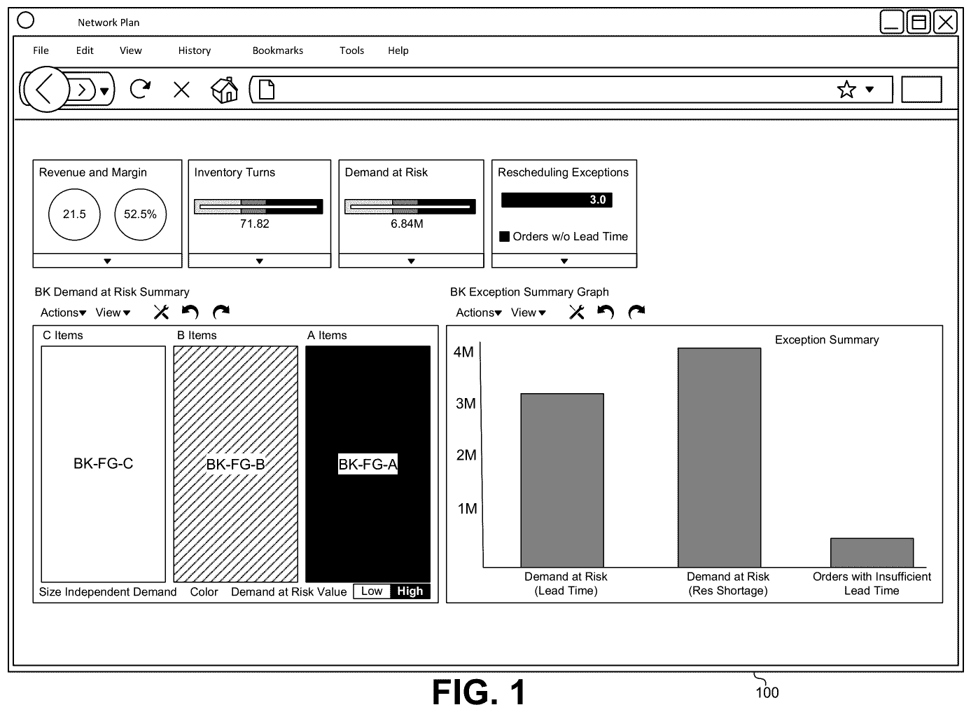

FIG. 1 illustrates a user interface 100 that displays a partial view of a network plan, according to some embodiments. Management solutions, such as the Oracle Supply Chain Management system, may analyze a network to generate a network plan. Generally, a network plan results from analyzing the network to generate a wide array of information, such as what components to make, what sub-components to purchase, how to efficiently use an inventory of components, which orders to prioritize, which resources should be utilized to provide each component, and/or other analytical data related to the network. For example, a primary output in the network plan may include a projected supply/demand for each component in the network, including how many components should be provided in each time window during a time interval or “plan horizon” for the plan, a location where the component should be provided, what resources or suppliers should be used to provide the component, what sub-components will be needed in each time window, and so forth.

The user interface 100 is an example of one of the many types of analysis that may be generated as part of the network plan. This user interface 100 illustrates how many components are in the plan, how many exceptions may be generated indicating components that are risk of not being provided according to schedule, the time or capacity constraints that may affect the components being provided, and so forth. Each of the controls or displays in the user interface 100 may be “drilled down” by the user to identify additional details for individual components or component types in the network.

Typical network management solutions may generate a network plan regularly to update component inventories, transportation plans, resource requirements, and so forth. For example, a typical network plan may be generated multiple times each day in order to generate a projected supply/demand for a defined time period (e.g., 30 days, six months, one year, two years, etc.). However, large-scale networks are very complex with millions of components, locations, resources, and other network entities and items. Therefore, generating the network plan from the available inputs may be a computationally complex and costly operation, particularly when repeated multiple times each day. Because the inputs tend to change rapidly, it is important to optimize the manner in which these network plans are generated. The specific algorithms and analyses that are performed to generate the network plan from the available inputs is beyond the scope of this disclosure, and available software products are available to perform this operation. Instead, the embodiments described herein focus on techniques for optimizing the inputs to the processes that generate the network plan in order to make these processes more efficient.

One method of optimizing the inputs involves identifying independent sub-groups in the network and solving these independent sub-groups in parallel. The final network plan may then be obtained by combining the solutions for the individual sub-groups. In addition to identifying independent sub-groups in the network based on a lack of explicit dependencies between components in those sub-groups, the embodiments described herein may also further partition the network into additional sub-groups by identifying constrained resources where those constraints may be “relaxed.” By relaxing these constraints, the resources may be considered “unconstrained” for purposes of subdividing the network. By breaking the problem up into numerous smaller sub-groups, the individual sub-groups can be processed in parallel and much faster than the overall network as a whole. This dramatically increases the speed with which a network plan may be generated using conventional algorithms.

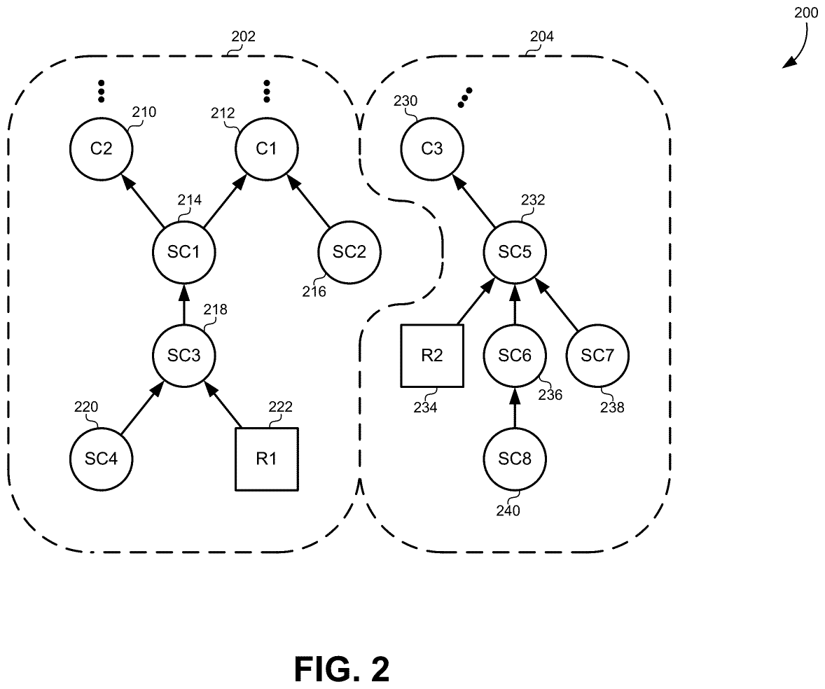

FIG. 2 illustrates a diagram of a network represented by a graph 200, according to some embodiments. While any data structure may be used to represent a network, the graph 200 is used herein as an example for how dependencies can be identified and constraints may be relaxed to divide the network into a plurality of sub-groups that can be analyzed individually. This graph 200 represents a greatly simplified version of a portion of a larger network graph. In practice, network graphs may include millions of nodes and may be far more complex.

The graph 200 may include a plurality of nodes representing different entities in the network. To simplify this representation, each node may represent a component or a resource that provides a component. “Components” may be used as a broad umbrella term in this disclosure, and may include finished groups, items, objects, assemblies, sub-assemblies, sub-components, and/or any other item that is used by or provided by the network. For example, a component may include a computer server represented by a node in the graph. Other nodes in the graph may represent components that are provided as sub-components to the computer server, such as processors, memory devices, printed circuit boards, and so forth. Each of the sub-components may also comprise additional sub-components that are represented as individual nodes in the graph. Collectively, any of these components or subcomponents may be referred to as “components” in this disclosure, whether they are part of a finished group or an intermediate assembly piece.

The graph 200 may also include nodes that may represent resources. As used herein, the term “resource” may refer to any device or entity that is used to provide a component. For example, a resource may include a machine, computing system, location, etc., that may be used to produce or provide a component. In another example, a resource may refer to a supplier or other entity that provides a component to the network.

The edges in the graph 200 may represent dependencies or relationships between the various components and/or resources. Some embodiments may use a directed graph, where edges represents one-way dependencies between nodes. For example, component 210 and component 212 may use a common sub-component 214. Component 212 may combine sub-component 214 and sub-component 216 into a final group or assembly. Sub-component 218 may incorporate sub-component 220. Sub-component 218 may also require resource 222 in order to be produced or provided. For example, resource 222 may be a specific piece of machinery or equipment used to incorporate sub-component 220 into sub-component 218. Resource 222 may alternatively be a supplier that provides equipment or components that are used for sub-component 218.

The network graph 200 may be provided as at least one of the inputs to an algorithm or process used to generate the network plan. In order to improve the efficiency of the algorithm or process used to generate the network plan, the network may be divided into sub-groups. This may be accomplished by dividing the graph 200 into independent sub-graphs. In the simplest case, a sub-graph may be considered independent when no dependencies are shared with other sub-graphs. In this example, the graph 200 may be divided into sub-graph 202 and sub-graph 204, as no explicit dependencies exist between sub-graph 202 and sub-graph 204. These types of independent sub-graphs 202, 204 may be identified by traversing the graph 200 to identify overlapping paths or dependencies.

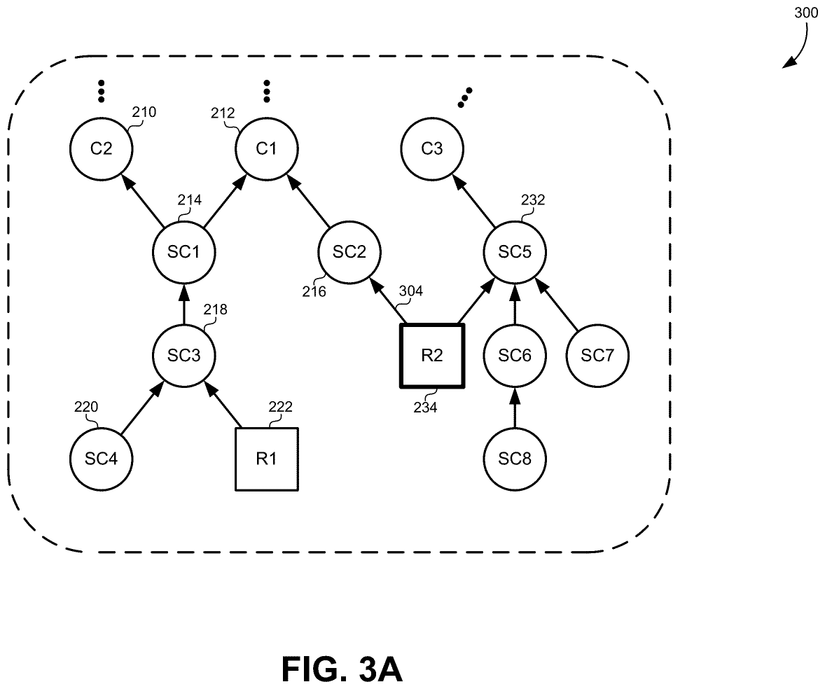

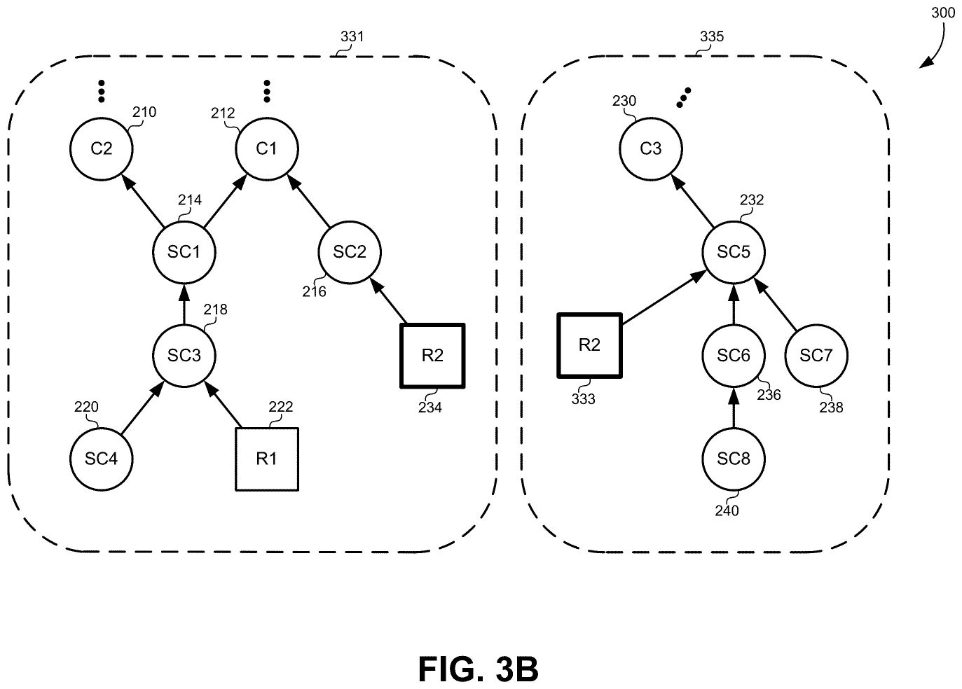

FIG. 3A illustrates a graph 300 that cannot initially be divided into independent sub-graphs based on dependencies alone, according to some embodiments. In graph 300, sub-component 216 includes a dependency on resource 234. However, sub-component 232 also includes a dependency on resource 234. This may indicate components that are provided from a same supplier or that require a same piece of equipment to be produced in the network. When traversing this graph 300, the algorithm may identify the shared dependency on resource 234, which prevents the network 300 from being divided into independent sub-graphs. Therefore, the entire graph 300 would be provided to the process for generating the network plan and analyzed as a whole.

FIG. 3B illustrates how the graph 300 can be divided into independent sub-graphs by relaxing constraints on dependencies, according to some embodiments. By relying on the structure of the graph 300 alone, it would initially appear that the graph 300 cannot be divided into independent sub-graphs because of the shared dependency on resource 234. However, knowledge of the actual resource 234 represented by this node may be used to determine whether this constraint may be relaxed. For example, the resource 234 may represent a piece of manufacturing equipment. The manufacturing equipment may be subject to a constrained value, such as a capacity limit for maximum number of components that may be produced using the equipment. If the actual usage requirements for sub-component 216 and sub-component 232 imposed on the resource 234 are less than this capacity limit, then some embodiments may identify the resource 234 as having constraints that may be relaxed for purposes of subdividing the graph 300.

In some embodiments, the constrained value (e.g., the usage) of the resource 234 may be estimated using techniques described below. This estimated value may then be compared to a threshold representing the constraint (e.g., a capacity limit). If the estimate of the constrained value is less than the threshold, then the resource 234 may be “shared” between multiple sub-graphs while still treating the sub-graphs independently in the network plan analysis. In this example, the graph 300 may be split into sub-graph 331 and sub-graph 335 by creating duplicate copies of the resource 234 for each dependency. Specifically, resource 234 may maintain its dependency with sub-component 216 in sub-graph 331. A duplicate resource 333 may be added to maintain the dependency with sub-component 232 in sub-graph 335. This allows the graph 300 to be subdivided into additional sub-graphs that would otherwise not be recognized by existing methods.

As a matter of terminology, a resource node that shares dependencies with additional components or other resources may initially be referred to as a “constrained” node, in that it is limited by the constraints (e.g., capacity, usage, ability to supply components) of the underlying resource. However, when the estimated demands on the resource by the dependent sub-components are less than a threshold associated with the constraint, the node or resource may be referred to as “unconstrained” and therefore may be able to be shared between different sub-graphs.

Note that resources in the graph 300 may represent suppliers of components. Alternatively, some embodiments may some interpret leaf nodes (i.e., nodes without dependent child nodes) as representing suppliers. In this case, these leaf component nodes may also be analyzed the same as shared resource nodes to identify constraints that may be relaxed such that the graph 300 can be further subdivided.

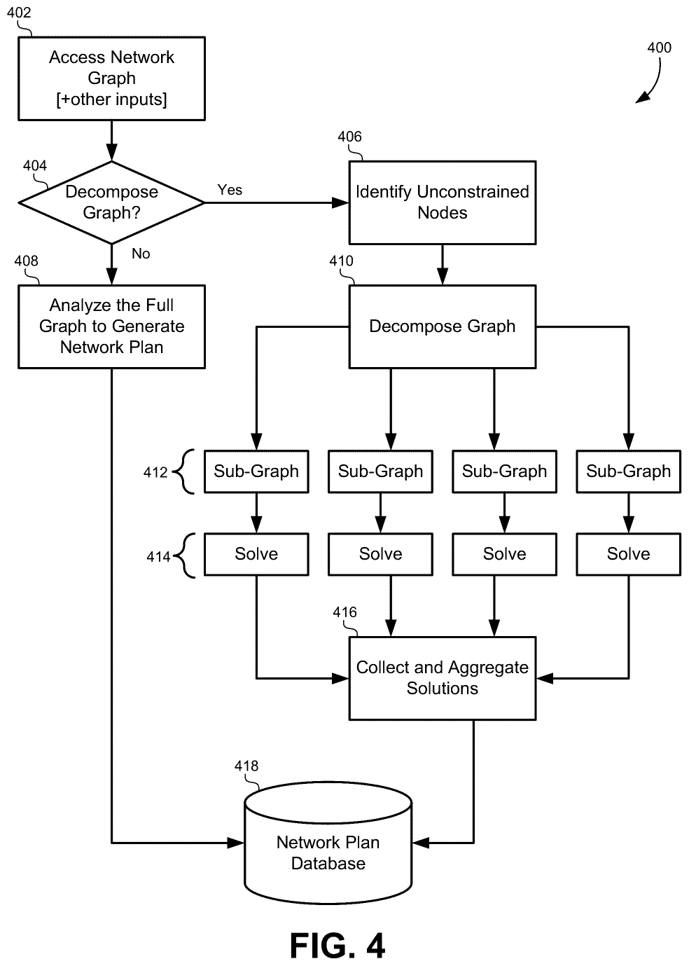

FIG. 4 illustrates a flowchart 400 of a process for efficiently subdividing a graph into sub-graphs when generating a network plan, according to some embodiments. The processes, tools, or algorithms used to generate the network plan may use a number of different inputs. These inputs may include accessing the network graph described above that includes nodes and edges representing components and resources and the dependencies between them (402). Other inputs may include a bill of materials, substitute components, sourcing, resources, alternate resources, supplier capacities, and so forth.

The method may also include determining whether to decompose the network graph (404). A process may process and analyze the full network graph to generate the network plan (408), and the resulting network plan may be stored in a network plan database (418). As described above, network plans may be generated multiple times every day, daily, weekly, or on an otherwise regular basis. Each of these network plans may be stored in the database for later reference or used for training a model as described below.

As an alternative to analyzing the full graph to generate the network plan, some embodiments may elect to decompose the graph. This decomposition process may include identifying “unconstrained” nodes in the graph (406). These nodes may share dependencies, but may have a constrained value (e.g., usage, capacity, etc.) that is below a threshold amount such that the resources represented by these nodes may be considered unconstrained. Multiple methods may be used for identifying these unconstrained nodes, including a machine-learning method described in detail below.

A list of the unconstrained nodes may be provided to a graph decomposition algorithm (410). For example, some embodiments may take the list of unconstrained nodes and generate duplicate copies for each corresponding dependency in the network. The network with duplicate copies may then be provided to the graph decomposition algorithm such that the graph can be decomposed into as many sub-graphs as possible. Many different methods may be used to decompose the graph, such as graph traversal, graph coloring, modular decomposition, maximal matching, and/or any other decomposition algorithm.

The decomposition algorithm may generate a plurality of sub-graphs (412). Each of the individual sub-graphs may be provided to the process for generating the network plan, referred to herein as a network solver (414). Each of these sub-graphs may be processed in parallel or sequentially by the network solver or multiple instances of the network solver to generate individual network plans for the sub-graphs. Each of these individual network plans may be aggregated and combined to generate a comprehensive network plan for the full network (416). This full network plan may then be stored in the network plan database (418).

It should be appreciated that the specific steps illustrated in FIG. 4 provide particular methods of processing a network graph according to various embodiments. Other sequences of steps may also be performed according to alternative embodiments. For example, alternative embodiments may perform the steps outlined above in a different order. Moreover, the individual steps illustrated in FIG. 4 may include multiple sub-steps that may be performed in various sequences as appropriate to the individual step. Furthermore, additional steps may be added or removed depending on the particular applications. Many variations, modifications, and alternatives also fall within the scope of this disclosure.

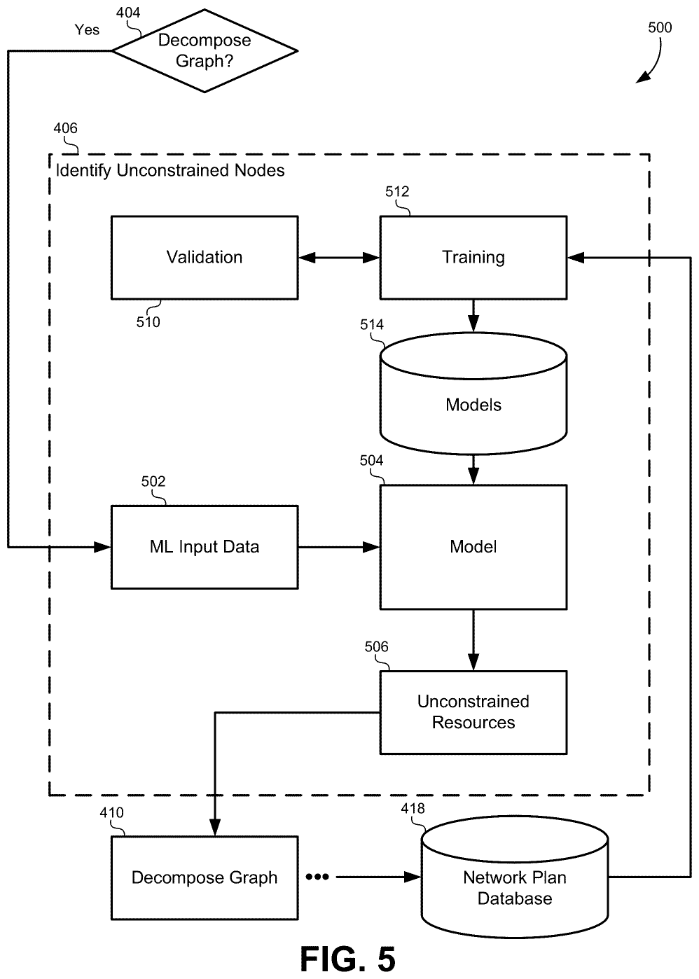

FIG. 5 illustrates a flowchart 500 of a method for using and training a machine-learning model to identify unconstrained nodes, according to some embodiments. This flowchart 500 focuses on the step (406) for identifying the unconstrained nodes in flowchart 400 of FIG. 4. Once the decision is made to decompose the graph (404), one or more of the inputs described above may be accessed (502) and provided to a trained machine-learning model (504). The model may be trained to identify nodes in the network graph that are unconstrained as defined above. For example, the model may be configured to receive the network graph, along with other inputs such as a bill of materials, and other information that may indicate quantities and needs for specific components. Some embodiments may also provide resource constraints as inputs to the model. The model may then generate inputs that indicate whether individual resource nodes in the network graph may be considered unconstrained despite multiple dependencies as illustrated in FIG. 3B above. The list of unconstrained resources (506) and/or their associated nodes in the network graph may be provided to the graph decomposition algorithm, used to generate individual network plans, and aggregated to form the full network plan stored in the network plan database (418).

The model may be implemented using any type of classification model. For example, some embodiments have used a neural network with internal weights and parameters that are trained to recognize unconstrained nodes in the network graph. Some embodiments may use a linear regression model, while other embodiments may use a logistic regression model. These model types are provided only by way of example and are not meant to be limiting.

Multiple models may be trained and stored in a model database (514). Based on results of a validation process (510), the models in the model database that perform the best may be selected for use in identifying the unconstrained resource nodes. The validation process may provide previous network plans from the network plan database (418) to the models in the model database (514) and evaluate the outputs of the models in comparison to the actual data from the network plans.

A specialized training procedure has been developed to train the model to identify the unconstrained nodes (512). Previous network plans in the network plan database typically will not include any indication of unconstrained nodes in a network graph. Similarly, the input data (502) provided to the model, including the network graph, will not directly indicate any unconstrained nodes. Therefore, the training process may need to prepare the training data from the network graph and other inputs and the resulting network plan outputs in order to train the model.

To build the training model, some embodiments may collect information from the model inputs and/or the resulting previous network plan outputs. The network plan may include a forecast for components or resources in the network over a time interval covered by the network plan (e.g., four weeks, one month, six months, one year, etc.). Therefore, some embodiments may divide this time interval into a plurality of discrete time windows or buckets. Each of these discrete time windows may identify if a specific component is needed in that time bucket, as well as if individual resources are used in that time bucket to provide the component. Other information that may be collected for generating the training data may include resource requirements such as the resource ID, resource time buckets, resource usage, and transaction IDs of transactions that use the resource. For resources that represent a supplier, the information may include an item ID, a supplier ID, a site ID, a time window or bucket, a supplier capacity available, a supplier capacity required, and so forth. The network graph or bill of materials may provide an end component demand for each time bucket, as well as a quantity from different resources involved in the transaction. The process may also obtain the allocated quantity and usage for each bucket for both resources and components. This information be collected from a list of transactions involving the resources or components.

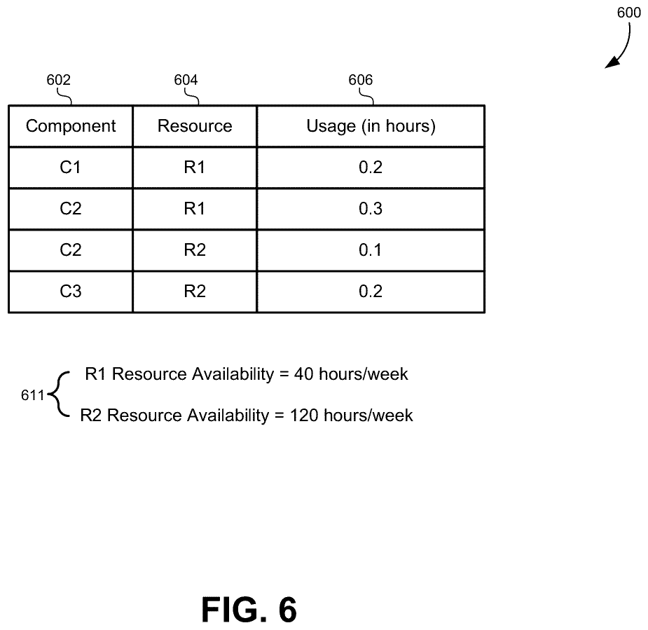

FIG. 6 illustrates an example of resource usage per component that may be used to generate training data, according to some embodiments. A table 600 illustrates components 602 and resources 604 that may be used by those components. The information in the table 600 may be retrieved from the input information described above that is available for training the model. Each row in the table 600 may correspond to a single edge or relationship in the network graph. For example, component C2 may be dependent on both resource R1 and resource R2, with each corresponding to a different edge between their associated nodes in the network graph. Additionally, the table 600 may include a usage 606 per component 602 associated with each resource 604. For example, in order to generate one component C1, resource R1 may use 0.2 hours of usage. Similarly, generating component C2 may use 0.3 hours on resource R1 and 0.1 hours on resource R2. Some embodiments may also identify a maximum resource availability 611 for each of the resources 604. This availability may be considered a threshold value to which the estimated usage per week may be compared as described below.

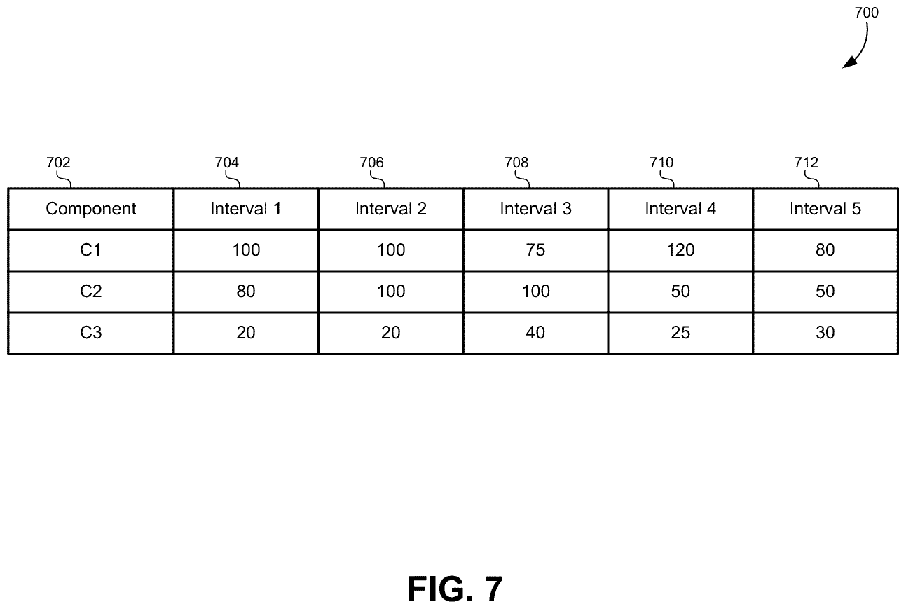

FIG. 7 illustrates an example of component requirements per individual time window, according to some embodiments. Table 700 may be generated by compiling component IDs from transactions that fall within each time window. By way of example, the total time interval covered by the network plan has been divided into five individual time windows or buckets 704, 706, 708, 710, 712. In this example, each of the time windows 704, 706, 708, 710, 712 may correspond to one week. However, other network plans may use varying window lengths. For example, the first four windows may represent one week, the next five windows may represent one month, and the next three windows may represent six-month intervals. In each of the time windows 704, 706, 708, 710, 712, the total number of each of the components 702 has been aggregated. For example, 100 units of component C1 may be used during the first time interval 704.

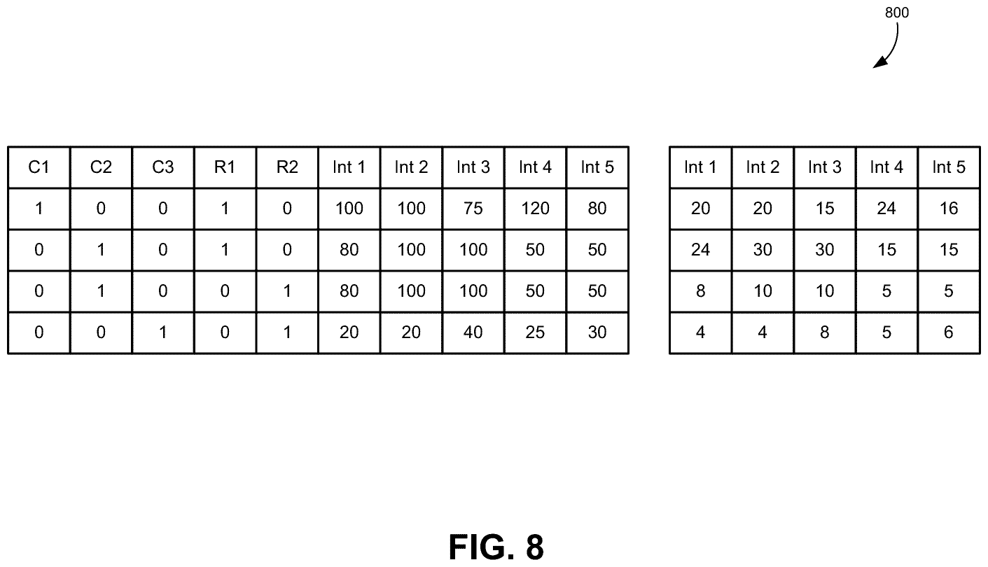

FIG. 8 illustrates an example of training data that may be derived from the resource and component information, according to some embodiments. The left-hand side of the table 800 represents the training data comprising the resource utilization in each time interval or bucket for each resource, based on the previous network plan solutions. Each row in the table 800 represents one combination of component and a required resource. For example, a row may represent a component demand quantity for each time window of one of the resources used to build the demand for that component. If multiple resources are used for a single component, then one row will be used for each distinct resource. Each of the time intervals in the table on the left-hand side includes the total number of the corresponding component of that row during each time window.

By using the usage per component information from the table 600 in FIG. 6, the right-hand side of the table 800 illustrates the total usage per corresponding resource for the corresponding component in each row. For example, in time interval 1, 100 units of component C1 are needed. Based on the 0.2 hours per component for resource R1, resource R1 may be used for a total of 20 hours during that week.

The right-hand side of the table 800 may represent an output of the model when trained as a regression model. For training purposes, the right-hand side of the table 800 may be used as training outputs that go along with the training inputs used to generate the corresponding previous network plan. This information in the right-hand side of the table 800 may be derived for each previous network plan and used to label the inputs used to generate the corresponding previous network plan.

When the right-hand side of the table 800 is generated as an output from a trained model, this information may be used to identify resources that are unconstrained. For example, each row corresponding to a particular resource may be aggregated and compared to a threshold. If the constraint value represented by the estimate in the aggregated rows is less than the threshold, the corresponding resource may be labeled as unconstrained using the definition described above. This process may be carried out for each time interval to ensure that no single time interval exceeds the threshold for the resource to be labeled as unconstrained. For example, the threshold representing the resource availability of R1 is approximately 40 hours per week from FIG. 6. The first and second row in the table 800 estimate the usage for R1 during the first time interval to be approximately 44 hours. Therefore, resource R1 would be labeled as constrained. The decomposition of the graph into sub-graphs would not be allowed to divide the sub-graphs at R1 because this could generate a bottleneck due to the usage of R1 that exceeds the threshold.

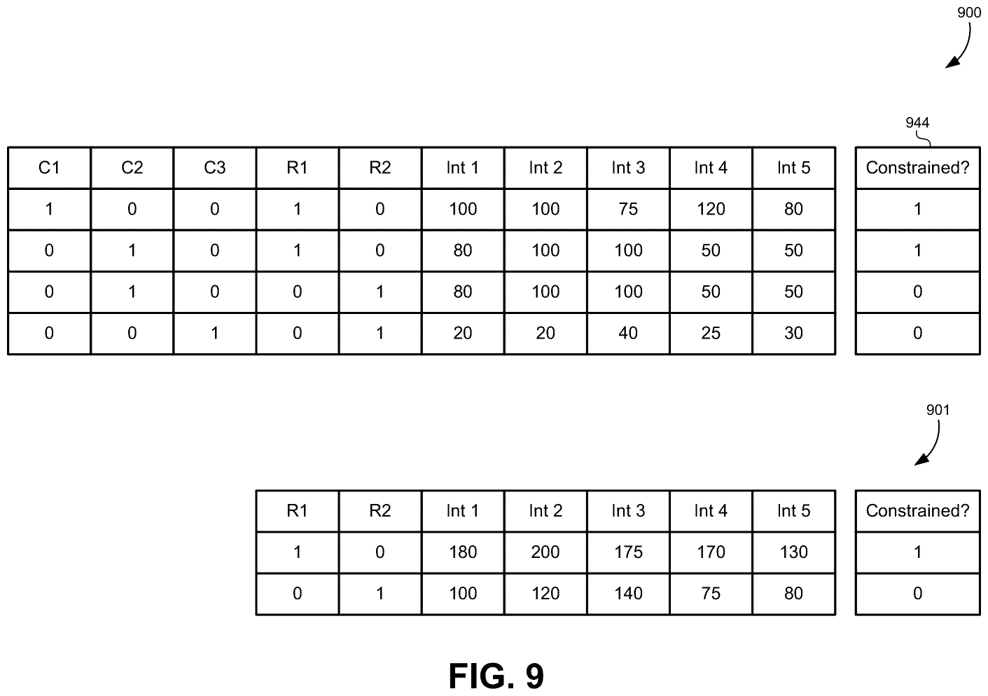

FIG. 9 illustrates data used in a logistic regression model, according to some embodiments. The left-hand side of the table 900 is similar to that of table 800 in FIG. 8. However, instead of simply outputting the estimated usage, the table 900 may output a binary indication 944 of whether the resource is constrained or unconstrained. For example, table 901 illustrates aggregated totals of estimated usage for each individual resource. The model may internally be trained using the threshold for each resource to output the binary indication 944 indicating whether the resource is constrained or unconstrained.

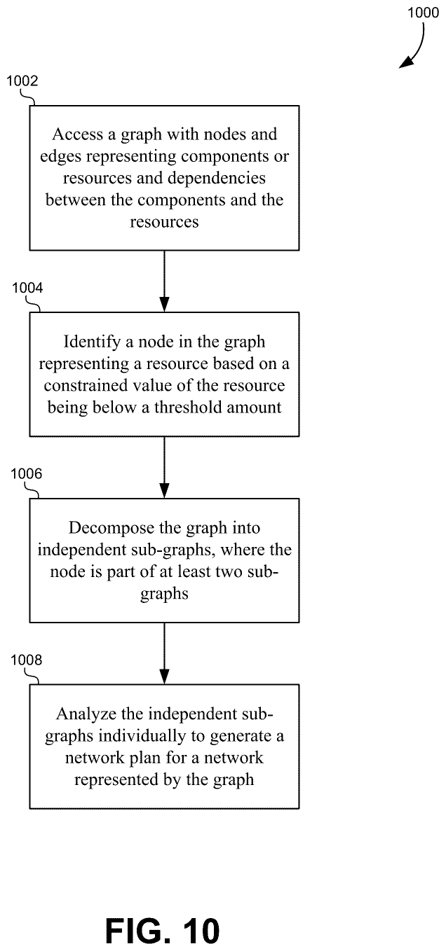

FIG. 10 illustrates a flowchart 1000 of a method of decomposing graphs of networks and independent sub-graphs based on node constraints, according to some embodiments. The method may include accessing a graph comprising nodes and edges (1002). The nodes may represent components and resources that provide the components in a network, and the edges may represent dependencies between the components and the resources as depicted above in FIG. 2, FIG. 3A and FIG. 3B. This graph may be one of the inputs provided to a process that solves the graph or generates a network plan that includes forecast for individual components and resources over a time interval.

The method may also include identifying a node in the graph representing a resource based on a constrained value of the resource being below a threshold amount (1004). The node may be identified (among many other nodes) as being unconstrained by providing the inputs to the process for generating the network plan to a train the model. The model may be trained to output an indication for each node as to whether the corresponding resource is constrained or unconstrained. The model may be trained and used as described above in FIGS. 5-9.

The method may additionally include decomposing the graph into a plurality of independent sub-graphs (1006). The node may be part of at least two independent sub-graphs in the plurality of independent sub-graphs. In some embodiments, the node may be duplicated for each dependency such that the graph can be subdivided into sub-graphs that each include one of the nodes representing the unconstrained resource. The method may further include analyzing the plurality of independent sub-graphs individually to generate a network plan for a network represented by the graph (1008).

It should be appreciated that the specific steps illustrated in FIG. 10 provide particular methods of decomposing graphs of networks and independent sub-graphs based on node constraints according to various embodiments. Other sequences of steps may also be performed according to alternative embodiments. For example, alternative embodiments may perform the steps outlined above in a different order. Moreover, the individual steps illustrated in FIG. 10 may include multiple sub-steps that may be performed in various sequences as appropriate to the individual step. Furthermore, additional steps may be added or removed depending on the particular applications. Many variations, modifications, and alternatives also fall within the scope of this disclosure.

Each of the methods described herein may be implemented by a computer system. Each step of these methods may be executed automatically by the computer system, and/or may be provided with inputs/outputs involving a user. For example, a user may provide inputs for each step in a method, and each of these inputs may be in response to a specific output requesting such an input, wherein the output is generated by the computer system. Each input may be received in response to a corresponding requesting output. Furthermore, inputs may be received from a user, from another computer system as a data stream, retrieved from a memory location, retrieved over a network, requested from a web service, and/or the like. Likewise, outputs may be provided to a user, to another computer system as a data stream, saved in a memory location, sent over a network, provided to a web service, and/or the like. In short, each step of the methods described herein may be performed by a computer system, and may involve any number of inputs, outputs, and/or requests to and from the computer system which may or may not involve a user. Those steps not involving a user may be said to be performed automatically by the computer system without human intervention. Therefore, it will be understood in light of this disclosure, that each step of each method described herein may be altered to include an input and output to and from a user, or may be done automatically by a computer system without human intervention where any determinations are made by a processor. Furthermore, some embodiments of each of the methods described herein may be implemented as a set of instructions stored on a tangible, non-transitory storage medium to form a tangible software product.

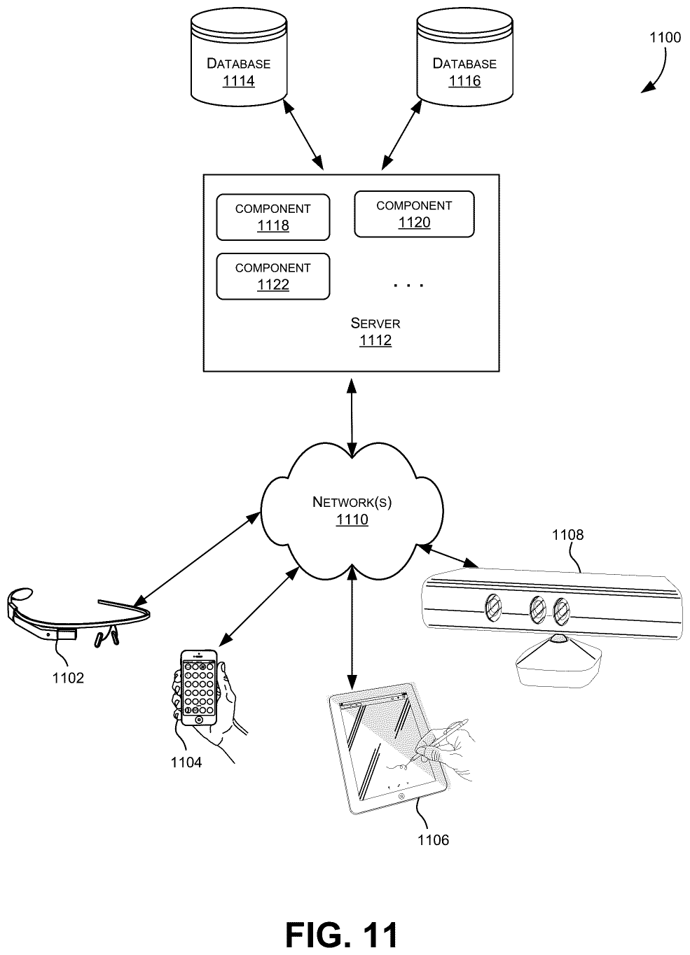

FIG. 11 depicts a simplified diagram of a distributed system 1100 for implementing one of the embodiments. In the illustrated embodiment, distributed system 1100 includes one or more client computing devices 1102, 1104, 1106, and 1108, which are configured to execute and operate a client application such as a web browser, proprietary client (e.g., Oracle Forms), or the like over one or more network(s) 1110. Server 1112 may be communicatively coupled with remote client computing devices 1102, 1104, 1106, and 1108 via network 1110.

In various embodiments, server 1112 may be adapted to run one or more services or software applications provided by one or more of the components of the system. In some embodiments, these services may be offered as web-based or cloud services or under a Software as a Service (SaaS) model to the users of client computing devices 1102, 1104, 1106, and/or 1108. Users operating client computing devices 1102, 1104, 1106, and/or 1108 may in turn utilize one or more client applications to interact with server 1112 to utilize the services provided by these components.

In the configuration depicted in the figure, the software components 1118, 1120 and 1122 of system 1100 are shown as being implemented on server 1112. In other embodiments, one or more of the components of system 1100 and/or the services provided by these components may also be implemented by one or more of the client computing devices 1102, 1104, 1106, and/or 1108. Users operating the client computing devices may then utilize one or more client applications to use the services provided by these components. These components may be implemented in hardware, firmware, software, or combinations thereof. It should be appreciated that various different system configurations are possible, which may be different from distributed system 1100. The embodiment shown in the figure is thus one example of a distributed system for implementing an embodiment system and is not intended to be limiting.

Client computing devices 1102, 1104, 1106, and/or 1108 may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 10, Palm OS, and the like, and being Internet, e-mail, short message service (SMS), Blackberry®, or other communication protocol enabled. The client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices 1102, 1104, 1106, and 1108 may be any other electronic device, such as a thin-client computer, an Internet-enabled gaming system (e.g., a Microsoft Xbox gaming console with or without a Kinect® gesture input device), and/or a personal messaging device, capable of communicating over network(s) 1110.

Although exemplary distributed system 1100 is shown with four client computing devices, any number of client computing devices may be supported. Other devices, such as devices with sensors, etc., may interact with server 1112.

Network(s) 1110 in distributed system 1100 may be any type of network that can support data communications using any of a variety of commercially-available protocols, including without limitation TCP/IP (transmission control protocol/Internet protocol), SNA (systems network architecture), IPX (Internet packet exchange), AppleTalk, and the like. Merely by way of example, network(s) 1110 can be a local area network (LAN), such as one based on Ethernet, Token-Ring and/or the like. Network(s) 1110 can be a wide-area network and the Internet. It can include a virtual network, including without limitation a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol); and/or any combination of these and/or other networks.

Server 1112 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. In various embodiments, server 1112 may be adapted to run one or more services or software applications described in the foregoing disclosure. For example, server 1112 may correspond to a server for performing processing described above according to an embodiment of the present disclosure.

Server 1112 may run an operating system including any of those discussed above, as well as any commercially available server operating system. Server 1112 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle, Microsoft, Sybase, IBM (International Business Machines), and the like.

In some implementations, server 1112 may include one or more applications to analyze and consolidate data feeds and/or event updates received from users of client computing devices 1102, 1104, 1106, and 1108. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 1112 may also include one or more applications to display the data feeds and/or real-time events via one or more display devices of client computing devices 1102, 1104, 1106, and 1108.

Distributed system 1100 may also include one or more databases 1114 and 1116. Databases 1114 and 1116 may reside in a variety of locations. By way of example, one or more of databases 1114 and 1116 may reside on a non-transitory storage medium local to (and/or resident in) server 1112. Alternatively, databases 1114 and 1116 may be remote from server 1112 and in communication with server 1112 via a network-based or dedicated connection. In one set of embodiments, databases 1114 and 1116 may reside in a storage-area network (SAN). Similarly, any necessary files for performing the functions attributed to server 1112 may be stored locally on server 1112 and/or remotely, as appropriate. In one set of embodiments, databases 1114 and 1116 may include relational databases, such as databases provided by Oracle, that are adapted to store, update, and retrieve data in response to SQL-formatted commands.

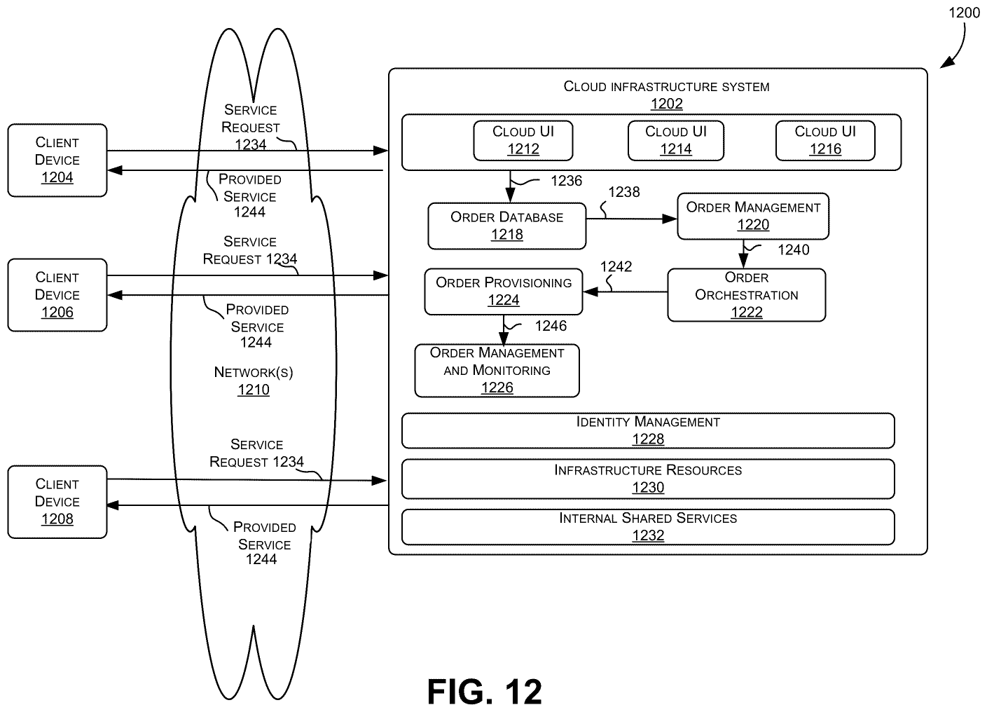

FIG. 12 is a simplified block diagram of one or more components of a system environment 1200 by which services provided by one or more components of an embodiment system may be offered as cloud services, in accordance with an embodiment of the present disclosure. In the illustrated embodiment, system environment 1200 includes one or more client computing devices 1204, 1206, and 1208 that may be used by users to interact with a cloud infrastructure system 1202 that provides cloud services. The client computing devices may be configured to operate a client application such as a web browser, a proprietary client application (e.g., Oracle Forms), or some other application, which may be used by a user of the client computing device to interact with cloud infrastructure system 1202 to use services provided by cloud infrastructure system 1202.

It should be appreciated that cloud infrastructure system 1202 depicted in the FIG. may have other components than those depicted. Further, the system shown in the figure is only one example of a cloud infrastructure system that may incorporate some embodiments. In some other embodiments, cloud infrastructure system 1202 may have more or fewer components than shown in the figure, may combine two or more components, or may have a different configuration or arrangement of components.

Client computing devices 1204, 1206, and 1208 may be devices similar to those described above for 1102, 1104, 1106, and 1108.

Although exemplary system environment 1200 is shown with three client computing devices, any number of client computing devices may be supported. Other devices such as devices with sensors, etc. may interact with cloud infrastructure system 1202.

Network(s) 1210 may facilitate communications and exchange of data between clients 1204, 1206, and 1208 and cloud infrastructure system 1202. Each network may be any type of network that can support data communications using any of a variety of commercially-available protocols, including those described above for network(s) 1110.

Cloud infrastructure system 1202 may comprise one or more computers and/or servers that may include those described above for server 1112.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 1202 may include a suite of applications, middleware, and database service offerings that are delivered to a customer in a self-service, subscription-based, elastically scalable, reliable, highly available, and secure manner. An example of such a cloud infrastructure system is the Oracle Public Cloud provided by the present assignee.

In various embodiments, cloud infrastructure system 1202 may be adapted to automatically provision, manage and track a customer's subscription to services offered by cloud infrastructure system 1202. Cloud infrastructure system 1202 may provide the cloud services via different deployment models. For example, services may be provided under a public cloud model in which cloud infrastructure system 1202 is owned by an organization selling cloud services (e.g., owned by Oracle) and the services are made available to the general public or different industry enterprises. As another example, services may be provided under a private cloud model in which cloud infrastructure system 1202 is operated solely for a single organization and may provide services for one or more entities within the organization. The cloud services may also be provided under a community cloud model in which cloud infrastructure system 1202 and the services provided by cloud infrastructure system 1202 are shared by several organizations in a related community. The cloud services may also be provided under a hybrid cloud model, which is a combination of two or more different models.

In some embodiments, the services provided by cloud infrastructure system 1202 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 1202. Cloud infrastructure system 1202 then performs processing to provide the services in the customer's subscription order.

In some embodiments, the services provided by cloud infrastructure system 1202 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that enable organizations (such as Oracle) to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support. Examples of platform services include, without limitation, Oracle Java Cloud Service (JCS), Oracle Database Cloud Service (DBCS), and others.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services (e.g., Oracle Fusion Middleware services), and Java cloud services. In one embodiment, database cloud services may support shared service deployment models that enable organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 1202 may also include infrastructure resources 1230 for providing the resources used to provide various services to customers of the cloud infrastructure system. In one embodiment, infrastructure resources 1230 may include pre-integrated and optimized combinations of hardware, such as servers, storage, and networking resources to execute the services provided by the PaaS platform and the SaaS platform.

In some embodiments, resources in cloud infrastructure system 1202 may be shared by multiple users and dynamically re-allocated per demand. Additionally, resources may be allocated to users in different time zones. For example, cloud infrastructure system 1230 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 1232 may be provided that are shared by different components or modules of cloud infrastructure system 1202 and by the services provided by cloud infrastructure system 1202. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 1202 may provide comprehensive management of cloud services (e.g., SaaS, PaaS, and IaaS services) in the cloud infrastructure system. In one embodiment, cloud management functionality may include capabilities for provisioning, managing and tracking a customer's subscription received by cloud infrastructure system 1202, and the like.

In one embodiment, as depicted in the figure, cloud management functionality may be provided by one or more modules, such as an order management module 1220, an order orchestration module 1222, an order provisioning module 1224, an order management and monitoring module 1226, and an identity management module 1228. These modules may include or be provided using one or more computers and/or servers, which may be general purpose computers, specialized server computers, server farms, server clusters, or any other appropriate arrangement and/or combination.

In exemplary operation 1234, a customer using a client device, such as client device 1204, 1206 or 1208, may interact with cloud infrastructure system 1202 by requesting one or more services provided by cloud infrastructure system 1202 and placing an order for a subscription for one or more services offered by cloud infrastructure system 1202. In certain embodiments, the customer may access a cloud User Interface (UI), cloud UI 1212, cloud UI 1214 and/or cloud UI 1216 and place a subscription order via these UIs. The order information received by cloud infrastructure system 1202 in response to the customer placing an order may include information identifying the customer and one or more services offered by the cloud infrastructure system 1202 that the customer intends to subscribe to.

After an order has been placed by the customer, the order information is received via the cloud UIs, 1212, 1214 and/or 1216.

At operation 1236, the order is stored in order database 1218. Order database 1218 can be one of several databases operated by cloud infrastructure system 1218 and operated in conjunction with other system elements.

At operation 1238, the order information is forwarded to an order management module 1220. In some instances, order management module 1220 may be configured to perform billing and accounting functions related to the order, such as verifying the order, and upon verification, booking the order.

At operation 1240, information regarding the order is communicated to an order orchestration module 1222. Order orchestration module 1222 may utilize the order information to orchestrate the provisioning of services and resources for the order placed by the customer. In some instances, order orchestration module 1222 may orchestrate the provisioning of resources to support the subscribed services using the services of order provisioning module 1224.

In certain embodiments, order orchestration module 1222 enables the management of business processes associated with each order and applies business logic to determine whether an order should proceed to provisioning. At operation 1242, upon receiving an order for a new subscription, order orchestration module 1222 sends a request to order provisioning module 1224 to allocate resources and configure those resources needed to fulfill the subscription order. Order provisioning module 1224 enables the allocation of resources for the services ordered by the customer. Order provisioning module 1224 provides a level of abstraction between the cloud services provided by cloud infrastructure system 1200 and the physical implementation layer that is used to provision the resources for providing the requested services. Order orchestration module 1222 may thus be isolated from implementation details, such as whether or not services and resources are actually provisioned on the fly or pre-provisioned and only allocated/assigned upon request.

At operation 1244, once the services and resources are provisioned, a notification of the provided service may be sent to customers on client devices 1204, 1206 and/or 1208 by order provisioning module 1224 of cloud infrastructure system 1202.

At operation 1246, the customer's subscription order may be managed and tracked by an order management and monitoring module 1226. In some instances, order management and monitoring module 1226 may be configured to collect usage statistics for the services in the subscription order, such as the amount of storage used, the amount data transferred, the number of users, and the amount of system up time and system down time.

In certain embodiments, cloud infrastructure system 1200 may include an identity management module 1228. Identity management module 1228 may be configured to provide identity services, such as access management and authorization services in cloud infrastructure system 1200. In some embodiments, identity management module 1228 may control information about customers who wish to utilize the services provided by cloud infrastructure system 1202. Such information can include information that authenticates the identities of such customers and information that describes which actions those customers are authorized to perform relative to various system resources (e.g., files, directories, applications, communication ports, memory segments, etc.) Identity management module 1228 may also include the management of descriptive information about each customer and about how and by whom that descriptive information can be accessed and modified.

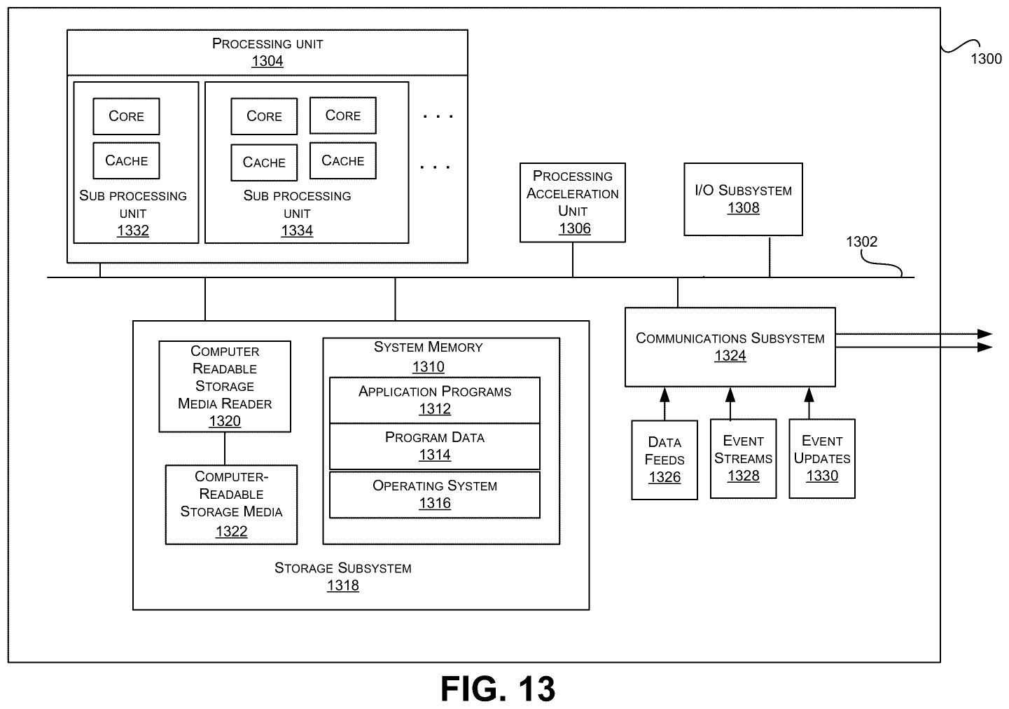

FIG. 13 illustrates an exemplary computer system 1300, in which various embodiments may be implemented. The system 1300 may be used to implement any of the computer systems described above. As shown in the figure, computer system 1300 includes a processing unit 1304 that communicates with a number of peripheral subsystems via a bus subsystem 1302. These peripheral subsystems may include a processing acceleration unit 1306, an I/O subsystem 1308, a storage subsystem 1318 and a communications subsystem 1324. Storage subsystem 1318 includes tangible computer-readable storage media 1322 and a system memory 1310.

Bus subsystem 1302 provides a mechanism for letting the various components and subsystems of computer system 1300 communicate with each other as intended. Although bus subsystem 1302 is shown schematically as a single bus, alternative embodiments of the bus subsystem may utilize multiple buses. Bus subsystem 1302 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1304, which can be implemented as one or more integrated circuits (e.g., a conventional microprocessor or microcontroller), controls the operation of computer system 1300. One or more processors may be included in processing unit 1304. These processors may include single core or multicore processors. In certain embodiments, processing unit 1304 may be implemented as one or more independent processing units 1332 and/or 1334 with single or multicore processors included in each processing unit. In other embodiments, processing unit 1304 may also be implemented as a quad-core processing unit formed by integrating two dual-core processors into a single chip.

In various embodiments, processing unit 1304 can execute a variety of programs in response to program code and can maintain multiple concurrently executing programs or processes. At any given time, some or all of the program code to be executed can be resident in processor(s) 1304 and/or in storage subsystem 1318. Through suitable programming, processor(s) 1304 can provide various functionalities described above. Computer system 1300 may additionally include a processing acceleration unit 1306, which can include a digital signal processor (DSP), a special-purpose processor, and/or the like.

I/O subsystem 1308 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1300 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1300 may comprise a storage subsystem 1318 that comprises software elements, shown as being currently located within a system memory 1310. System memory 1310 may store program instructions that are loadable and executable on processing unit 1304, as well as data generated during the execution of these programs.

Depending on the configuration and type of computer system 1300, system memory 1310 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1304. In some implementations, system memory 1310 may include multiple different types of memory, such as static random access memory (SRAM) or dynamic random access memory (DRAM). In some implementations, a basic input/output system (BIOS), containing the basic routines that help to transfer information between elements within computer system 1300, such as during start-up, may typically be stored in the ROM. By way of example, and not limitation, system memory 1310 also illustrates application programs 1312, which may include client applications, Web browsers, mid-tier applications, relational database management systems (RDBMS), etc., program data 1314, and an operating system 1316. By way of example, operating system 1316 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Storage subsystem 1318 may also provide a tangible computer-readable storage medium for storing the basic programming and data constructs that provide the functionality of some embodiments. Software (programs, code modules, instructions) that when executed by a processor provide the functionality described above may be stored in storage subsystem 1318. These software modules or instructions may be executed by processing unit 1304. Storage subsystem 1318 may also provide a repository for storing data used in accordance with some embodiments.

Storage subsystem 1300 may also include a computer-readable storage media reader 1320 that can further be connected to computer-readable storage media 1322. Together and, optionally, in combination with system memory 1310, computer-readable storage media 1322 may comprehensively represent remote, local, fixed, and/or removable storage devices plus storage media for temporarily and/or more permanently containing, storing, transmitting, and retrieving computer-readable information.

Computer-readable storage media 1322 containing code, or portions of code, can also include any appropriate media, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 1300.

By way of example, computer-readable storage media 1322 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1322 may include, but is not limited to, Zip® drives, flash memory cards, universal serial bus (USB) flash drives, secure digital (SD) cards, DVD disks, digital video tape, and the like. Computer-readable storage media 1322 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1300.

Communications subsystem 1324 provides an interface to other computer systems and networks. Communications subsystem 1324 serves as an interface for receiving data from and transmitting data to other systems from computer system 1300. For example, communications subsystem 1324 may enable computer system 1300 to connect to one or more devices via the Internet. In some embodiments communications subsystem 1324 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1324 can provide wired network connectivity (e.g., Ethernet) in addition to or instead of a wireless interface.

In some embodiments, communications subsystem 1324 may also receive input communication in the form of structured and/or unstructured data feeds 1326, event streams 1328, event updates 1330, and the like on behalf of one or more users who may use computer system 1300.

By way of example, communications subsystem 1324 may be configured to receive data feeds 1326 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1324 may also be configured to receive data in the form of continuous data streams, which may include event streams 1328 of real-time events and/or event updates 1330, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 1324 may also be configured to output the structured and/or unstructured data feeds 1326, event streams 1328, event updates 1330, and the like to one or more databases that may be in communication with one or more streaming data source computers coupled to computer system 1300.

Computer system 1300 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1300 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, other ways and/or methods to implement the various embodiments should be apparent.

In the foregoing description, for the purposes of explanation, numerous specific details were set forth in order to provide a thorough understanding of various embodiments. It will be apparent, however, that some embodiments may be practiced without some of these specific details. In other instances, well-known structures and devices are shown in block diagram form.

The foregoing description provides exemplary embodiments only, and is not intended to limit the scope, applicability, or configuration of the disclosure. Rather, the foregoing description of various embodiments will provide an enabling disclosure for implementing at least one embodiment. It should be understood that various changes may be made in the function and arrangement of elements without departing from the spirit and scope of some embodiments as set forth in the appended claims.

Specific details are given in the foregoing description to provide a thorough understanding of the embodiments. However, it will be understood that the embodiments may be practiced without these specific details. For example, circuits, systems, networks, processes, and other components may have been shown as components in block diagram form in order not to obscure the embodiments in unnecessary detail. In other instances, well-known circuits, processes, algorithms, structures, and techniques may have been shown without unnecessary detail in order to avoid obscuring the embodiments.

Also, it is noted that individual embodiments may have been described as a process which is depicted as a flowchart, a flow diagram, a data flow diagram, a structure diagram, or a block diagram. Although a flowchart may have described the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to portable or fixed storage devices, optical storage devices, wireless channels and various other mediums capable of storing, containing, or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In the foregoing specification, features are described with reference to specific embodiments thereof, but it should be recognized that not all embodiments are limited thereto. Various features and aspects of some embodiments may be used individually or jointly. Further, embodiments can be utilized in any number of environments and applications beyond those described herein without departing from the broader spirit and scope of the specification. The specification and drawings are, accordingly, to be regarded as illustrative rather than restrictive.

Additionally, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

What is claimed is:

1. One or more non-transitory computer-readable media comprising instructions that, when executed by one or more processors, cause the one or more processors to perform operations comprising:
accessing a graph comprising nodes and edges, wherein the nodes represent components and resources that provide the components in a network, and the edges represent dependencies between the components and the resources;
identifying a node in the graph representing a resource based on a constrained value of the resource being below a threshold amount;
decomposing the graph into a plurality of independent sub-graphs, wherein the node is part of at least two independent sub-graphs in the plurality of independent sub-graphs; and
analyzing the plurality of independent sub-graphs individually to generate a network plan for a network represented by the graph.

2. The one or more non-transitory computer-readable media of claim 1, wherein the graph comprises a directed graph, and directions of the edges in the graph represent directional dependencies between the components in the resources.

3. The one or more non-transitory computer-readable media of claim 2, wherein an edge in the directed graph connects a node representing a first component to another node representing a second component that is used by the first component.

4. The one or more non-transitory computer-readable media of claim 1, wherein the network plan is generated to identify a number of each component that should be provided by the network within a time window.

5. The one or more non-transitory computer-readable media of claim 1, wherein the network plan is generated to identify which resources should be used by the network to provide the components.

6. The one or more non-transitory computer-readable media of claim 1, wherein identifying a node in the graph comprises using a machine-learning model to identify the node as being unconstrained.

7. The one or more non-transitory computer-readable media of claim 6, wherein the model comprises a neural network.

8. The one or more non-transitory computer-readable media of claim 6, wherein the model comprises a linear regression model that estimates constrained values for the resources in the network.

9. The one or more non-transitory computer-readable media of claim 8, wherein the constrained values are compared to thresholds to identify whether nodes are unconstrained.

10. The one or more non-transitory computer-readable media of claim 6, wherein the model comprises a logistic regression model that generates binary outputs indicating whether nodes are unconstrained in the network.

11. The one or more non-transitory computer-readable media of claim 1, wherein the operations further comprise training a machine-learning model to identify unconstrained nodes in the network.

12. The one or more non-transitory computer-readable media of claim 11, wherein training the machine-learning model comprises using previous network plans generated for the network as input training data.

13. The one or more non-transitory computer-readable media of claim 11, wherein training the machine-learning model comprises dividing a time interval covered by the network plan into a plurality of discrete time windows.

14. The one or more non-transitory computer-readable media of claim 13, wherein training the machine-learning model further comprises identifying discrete time windows where each of the components in the networks are required.

15. The one or more non-transitory computer-readable media of claim 14, wherein training the machine-learning model further comprises identifying the resources used for each of the components in each of the discrete time windows.

16. The one or more non-transitory computer-readable media of claim 15, wherein training the machine-learning model further comprises determining a usage for the resources in each of the discrete time windows, and comparing the usage for each of the resources to corresponding threshold amounts in each of the discrete time windows.

17. The one or more non-transitory computer-readable media of claim 1, wherein the constrained value represents a usage of the resource.

18. The one or more non-transitory computer-readable media of claim 1, wherein the constrained value represents a capacity of a supplier in the network.

19. A method of decomposing graphs of networks into independent sub-graphs based on node constraints, the method comprising:
accessing a graph comprising nodes and edges, wherein the nodes represent components and resources that provide the components in a network, and the edges represent dependencies between the components and the resources;
identifying a node in the graph representing a resource based on a constrained value of the resource being below a threshold amount;
decomposing the graph into a plurality of independent sub-graphs, wherein the node is part of at least two independent sub-graphs in the plurality of independent sub-graphs; and
analyzing the plurality of independent sub-graphs individually to generate a network plan for a network represented by the graph.

20. A system comprising:
one or more processors; and
one or more memory devices comprising instructions that, when executed by the one or more processors, cause the one or more processors to perform operations comprising:
accessing a graph comprising nodes and edges, wherein the nodes represent components and resources that provide the components in a network, and the edges represent dependencies between the components and the resources;
identifying a node in the graph representing a resource based on a constrained value of the resource being below a threshold amount;
decomposing the graph into a plurality of independent sub-graphs, wherein the node is part of at least two independent sub-graphs in the plurality of independent sub-graphs; and
analyzing the plurality of independent sub-graphs individually to generate a network plan for a network represented by the graph.
